(19) United States
(12) Patent Application Publication
(10) Pub. No.: US 2013/0293334 A1
(43) Pub. Date: Nov. 7, 2013

(54) MULTILAYER INDUCTOR AND METHOD OF MANUFACTURING THE SAME

(71) Applicant: Sung Sik SHIN, Suwon (KR)

(72) Inventor: Sung Sik SHIN, Suwon (KR)

(73) Assignee: Samsung Electro-Mechanics Co., Ltd.

(21) Appl. No.: 13/558,125

(22) Filed: Jul. 25, 2012

(30) Foreign Application Priority Data
May 2, 2012 (KR) 10-2012-0046562

(51) Int. Cl. H01F 27/29

(52) U.S. Cl. 336/192

(57) ABSTRACT

There is provided a multilayer inductor including: an inductor body formed of a material including metal powder particles, a ferrite, and a polymer resin; a coil part having a conductive circuit and a conductive via formed in the inductor body; and external electrodes formed on ends of the inductor body.

### CROSS-REFERENCE TO RELATED APPLICATIONS

This application claims the priority of Korean Patent Application No. 10-2012-0046562 filed on May 2, 2012, in the Korean Intellectual Property Office, the disclosure of which is incorporated herein by reference.

### BACKGROUND OF THE INVENTION

1. Field of the Invention

The present invention relates to a multilayer inductor and a method of manufacturing the same.

2. Description of the Related Art

Provided as representative electronic components using a ceramic material are a capacitor, an inductor, a piezoelectric element, a varistor, a thermistor, and the like.

Among these ceramic electronic components, an inductor, as well as a resistor and a capacitor, is a main passive element constituting an electronic circuit, and may serve to remove noise or constitute an inductor-capacitor (LC) resonance circuit.

The inductor may be manufactured by winding or printing a coil on a ferrite core and forming electrodes at both ends thereof, or by printing internal electrodes on a magnetic material or a dielectric material and stacking them.

An inductor may be classified as one of several different types thereof, such as a multilayer type, a wire type, a thin film type, or the like, according to a structure thereof. Each of the inductors is different in view of a method for the manufacturing thereof, as well as a range of applications thereof.

Among these types of inductor, the wire type inductor may be formed by winding a coil around a ferrite core. In the case of increasing the number of windings in order to obtain high levels of inductance and capacitance, stray capacitance between the coils, that is, capacitance between conducting wires, may be generated, such that high frequency characteristics in a product may be deteriorated.

In addition, the multilayer inductor may be manufactured as a stack in which a plurality of ceramic sheets formed of ferrite or a low k-dielectric are stacked.

Coil-shaped metal patterns are formed on the respective ceramic sheets. The coil-shaped metal patterns, respectively formed on the ceramic sheets, maybe sequentially connected by conductive vias formed in the ceramic sheets, and may have a structure in which the metal patterns overlap one another in a vertical direction in which the sheets are stacked.

An inductor body configuring the multilayer inductor according to the related art has been formed of a ferrite material including nickel (Ni), zinc (Zn), copper (Cu), andiron (Fe) formed in a quaternary manner.

However, since the ferrite material has a saturation magnetization value lower than that of metal, high current characteristics required for various electronic products may not be implemented.

Therefore, the inductor body configured with the multilayer inductor formed of metal may have a relatively increased saturation magnetization value compared to that of the above-mentioned inductor body formed of a ferrite. However, in this case, eddy current loss and hysteresis loss at a high frequency may be increased, such that loss in the material may grow increasingly worse.

In order to decrease loss in the material, a structure having an insulating interval between metal powder particles provided by a polymer resin has been applied in the related art. However, since a volume fraction of the metal is decreased, an effect of increasing the saturation magnetization value, an advantage of metal as described above, may not be appropriately implemented.

Related art document 1 relates to an inductor, which does not include ferrite as a material configuring the inductor body.

### RELATED ART DOCUMENT

(Patent Document 1) Japanese Patent Laid-Open Publication No.

### SUMMARY OF THE INVENTION

An aspect of the present invention provides a multilayer inductor able to maintain reliability at a predetermined level and improve an inductance value at high current.

According to an aspect of the present invention, there is provided a multilayer inductor including: an inductor body formed of a material including metal powder particles, a ferrite, and a polymer resin; a coil part having a conductive circuit and a conductive via formed in the inductor body; and external electrodes formed on ends of the inductor body.

A portion of the inductor body surrounding the conductive circuit and the conductive via of the coil part may be filled with the material including the metal powder particles, the ferrite, and the polymer resin.

The multilayer inductor may further include an upper cover layer formed in an upper portion of the inductor body, and a lower cover layer formed in a lower portion of the inductor body.

The upper cover layer and the lower cover layer may be formed of the material including the metal powder particles, the ferrite, and the polymer resin.

The multilayer inductor may further include an insulating layer formed on outer surfaces of the inductor body, the upper cover layer and the lower cover layer.

The metal powder particles may have a particle size of 1 μm to 50 μm.

The metal powder particles may include a mixture of two or more metal powder particles having different particle sizes.

The metal powder particles may include one of iron-nickel (Fe—Ni) and iron-nickel-silicon (Fe—Ni—Si).

The ferrite may be a nickel-zinc-copper (Ni—Zn—Cu) ferrite.

The polymer resin may be a thermosetting resin including at least one of Novolac, Epoxy Resin, Phenoxy Type Epoxy Resin, BPA Type Epoxy Resin, BPF Type Epoxy Resin, Hydrogenated BPA Epoxy Resin, Dimer Acid Modified Epoxy Resin, Urethane Modified Epoxy Resin, Rubber Modified Epoxy Resin, and DCPD Type Epoxy Resin.

The conductive circuit may be formed of a material including at least one of silver (Ag), copper (Cu), and a copper alloy.

According to another aspect of the present invention, there is provided a method of manufacturing a multilayer inductor including: preparing a plurality of sheets having a conductive circuit and a conductive via formed thereon and therein and formed of a material including metal powder particles, a ferrite, and a polymer resin; and forming an inductor body by stacking the plurality of sheets while allowing one end of the conductive circuit formed on each sheet to contact the conductive via formed in an adjacent sheet to thereby form a coil part.

In the preparing of the plurality of sheets, a portion of the inductor body surrounding the conductive circuit and the conductive via may be formed of the material including the metal powder particles, the ferrite, and the polymer resin.

After the forming of the inductor body, the method may further include forming a lower cover layer in a lower portion of the inductor body, the lower cover layer being formed of the material including the metal powder particles, the ferrite, and the polymer resin; and forming an upper cover layer in an upper portion of the inductor body, the upper cover layer being formed of the material including the metal powder particles, the ferrite, and the polymer resin.

The upper cover layer and the lower cover layer may be formed by stacking a plurality of cover sheets, the cover sheets being formed of a mixture of the metal powder particles and the ferrite in the polymer resin.

The upper cover layer and the lower cover layer may be formed by printing a paste on an upper surface and a lower surface of the inductor body, respectively, the paste being formed of the material including the metal powder particles, the ferrite, and the polymer resin.

After the forming of the inductor body, the method may further include forming external electrodes on ends of the inductor body.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically illustrating a structure of a multilayer inductor according to an embodiment of the present invention;

FIG. 2 is a cross-sectional view of the multilayer inductor according to the embodiment of the present invention, taken along line A-A′ of FIG. 1; and

FIG. 3 is a cross-sectional view illustrating the multilayer inductor according to another embodiment of the present invention, taken along line A-A′ of FIG. 1.

### DETAILED DESCRIPTION OF THE EMBODIMENTS

Hereinafter, embodiments of the present invention will be described in detail with reference to the accompanying drawings so that those skilled in the art may easily practice the present invention.

The invention may, however, be embodied in many different forms and should not be construed as being limited to the embodiments set forth herein.

Rather, these embodiments are provided so that this disclosure will be thorough and complete, and will fully convey the concept of the invention to those skilled in the art.

Therefore, in the drawings, the shapes and dimensions of elements may be exaggerated for clarity, and the same reference numerals will be used throughout to designate the same or like elements.

In addition, like reference numerals denote parts performing similar functions and actions throughout the drawings.

Unless explicitly described to the contrary, the word “comprise” and variations such as “comprises” or “comprising,” will be understood to imply the inclusion of stated elements but not the exclusion of any other elements.

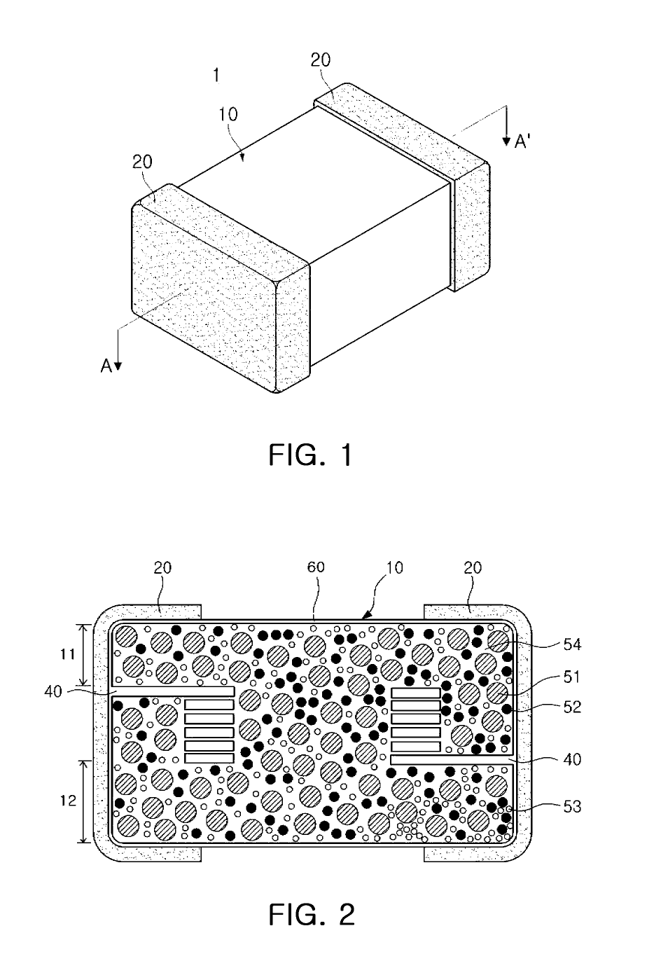

FIG. 1 is a perspective view schematically illustrating a structure of a multilayer inductor according to an embodiment of the present invention, and FIG. 2 is a cross-sectional view of the multilayer inductor according to the embodiment of the present invention taken along line A-A′ of FIG. 1.

Referring to FIGS. 1 and 2, a multilayer inductor 1 according to the embodiment of the present invention may include metal powder particles 51 and 52, an inductor body 10 formed of a material including ferrite 53 and a polymer resin 54, a coil part 40 formed in the inductor body 10, and a pair of external electrodes 20 formed on both ends of the inductor body 10.

Here, the metal powder particles 51 and 52 included in the inductor body 10 may have various sizes. Preferably, based on an average particle size, only particles having the same size, among particles having a size of 1 to 50 μm may be used, or two or more kinds of particles having different sizes, for example, a first metal powder particle 51 of 30 μm and a second metal powder particle 52 of 3 μm, smaller than the first metal powder particle, may be used by being mixed.

The metal powder particles 51 and 52 may be formed of a material including one of iron-nickel (Fe—Ni) and iron-nickel-silicon (Fe—Ni—Si), but are not limited thereto.

In addition, the ferrite 53 included in the inductor body 10 may be formed of nickel-zinc-copper ferrite, or the like, but is not limited thereto.

In addition, the ferrite 53 may have a particle size of 2 μm or less, but is not limited thereto.

In addition, the polymer resin 54 included in the inductor body 10 may provide insulation between a plurality of metal powder particles 51 and 52, and may be formed of a thermosetting resin.

Examples of the thermosetting resin may include Novolac, Epoxy Resin, Phenoxy Type Epoxy Resin, BPA Type Epoxy Resin, BPF Type Epoxy Resin, Hydrogenated BPA Epoxy Resin, Dimer Acid Modified Epoxy Resin, Urethane Modified Epoxy Resin, Rubber Modified Epoxy Resin, DCPD Type Epoxy Resin, or the like. Among these, one or a mixture of two or more thereof may be used.

The inductor body 10 according to the present embodiment may be formed by stacking a plurality of sheets formed of the material including the metal powder particles 51 and 52, the ferrite 53, and the polymer resin 54.

However, the present invention is not limited thereto. For example, the inductor body 10 may be formed by various methods, such as a method of printing a paste formed of the material including the metal powder particles 51 and 52, the ferrite 53, and the polymer resin 54 to have a predetermined thickness, or a method of injecting and compressing the paste in a mold, or the like, as needed.

Here, the number of multilayer sheets or the thickness of the paste printed to form the inductor body 10 may be appropriately determined in consideration of electrical characteristics such as inductance, or the like, required for the multilayer inductor 1.

Respective sheets forming the inductor body 10 as described above may have a conductive circuit (not shown) formed on one surface thereof, and a conductive via (not shown) penetrated through the sheets in a thickness direction thereof so as to be connected to adjacent conductive circuits positioned thereabove and therebelow.

Therefore, one ends of conductive circuits formed on respective sheets may be electrically connected through the conductive via formed in adjacent sheets, to thereby form the coil part 40.

In addition, both ends of the coil part 40 may be exposed to the outside through both ends of the inductor body 10, such that the coil part 40 may contact and be electrically connected to the pair of external electrodes 20 formed on both ends of the inductor body 10.

The conductive circuit may be formed by thick film printing, coating, depositing, sputtering, or the like, but is not limited thereto.

The conductive via may be provided by forming a through hole on respective sheets in the thickness direction and filling the through hole with a conductive paste or the like, but is not limited thereto.

In addition, the material forming the conductive circuit and the conductive paste forming the conductive via may include at least one of silver (Ag), copper (Cu), and a copper alloy.

In addition, the multilayer inductor 1 may further include an upper cover layer 11 formed in an upper portion of the inductor body 10, and a lower cover layer 12 formed in a lower portion of the inductor body 10.

A material for the upper cover layer 11 and the lower cover layer 12 is not particularly limited; however, it may include the metal powder particles 51 and 52 having different sizes, the ferrite 53, and the polymer resin 54, which is identical to the material for the inductor body 10.

Here, the metal powder particles 51 and 52 included in the upper cover layer 11 and the lower cover layer 12 may have different sizes.

Meanwhile, an insulating layer 60 may be formed to surround an outer surface of the inductor body 10.

In the case in which the upper cover layer 11 and the lower cover layer 12 are formed in the upper and lower portions of the inductor body 10, the insulating layer 60 may have a rectangular shape covering all of the outer surfaces of the upper cover layer 11 and the lower cover layer 12 as well as both sides and both ends of the inductor body 10.

The external electrodes 20 may be formed on both ends of the inductor body 10 to cover end portions thereof, and may respectively contact both ends of the coil part 40 exposed through both ends of the inductor body 10, to thereby implement electric connections therewith.

The external electrodes 20 may be formed on both ends of the inductor body 10 by submerging the inductor body 10 in the conductive paste, or by various methods such as printing, depositing, sputtering, and the like.

The conductive paste may be formed of a material including anyone of silver (Ag), copper (Cu), and a copper (Cu) alloy, but is not limited thereto.

In addition, a nickel (Ni) plating layer (not shown) and a tin (Sn) plating layer (not shown) may also be formed on the outer surfaces of respective external electrodes 20, if needed.

Hereinafter, an operation of the multilayer inductor 1 according to the embodiment of the present invention will be described.

In the case in which the inductor body in the multilayer inductor is only formed of the ferrite material, since a saturation magnetization value thereof is relatively low as compared to that of metal, inductance may be significantly deteriorated at the time of using a high current, such that it may be difficult to obtain a desired inductance value at high current.

In addition, in the case in which the inductor body is formed of metal, a saturation magnetization value thereof is high. However, eddy current loss and hysteresis loss at high frequency may be increased, thereby generating a significant loss in the material.

However, since the multilayer inductor 1 according to the embodiment of the present invention has the inductor body 10 formed of the material including the metal powder particles 51 and 52, the ferrite 53, and the polymer resin 54, the advantages of metal maybe used to prevent the inductance L value from being decreased even at high current.

In addition, since the volume fraction of magnetic particles in the inductor body 10 is increased by the ferrite 53 dispersedly included in the polymer resin 54 of the inductor body 10, the capacity of the multilayer inductor 1 may be increased.

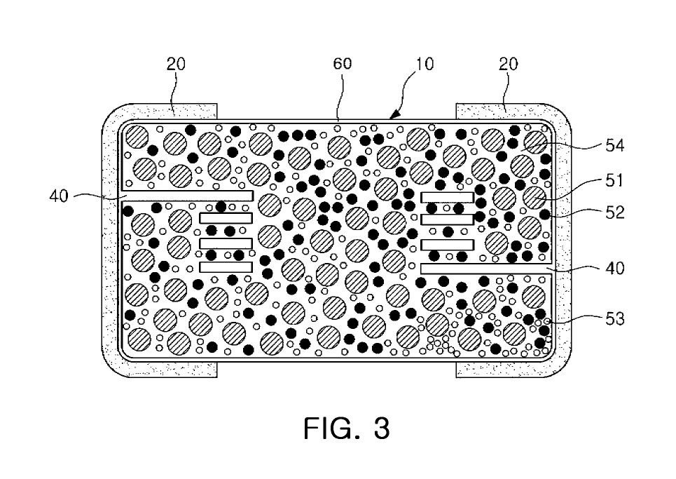

FIG. 3 is a cross-sectional view illustrating the multilayer inductor according to another embodiment of the present invention taken along line A-A′ of FIG. 1. The same reference numerals will be used to denote the same elements as those of the above-described embodiment of the present invention. Hereinafter, other elements different from those of the above-described embodiment of the present invention will mainly be described.

Referring to FIG. 3, in the multilayer inductor 1 according to the embodiment of the present invention, the portion of the inductor body 10 surrounding the conductive circuit and the conductive via configuring the coil part 40 may be formed of a material including the metal powder particles 51 and 52, the ferrite 53, and the polymer resin 54, which is the same as the material for forming the inductor body 10.

As described above, the portion of the inductor body 10 surrounding the conductive circuit and the conductive via is filled with the material including the metal powder particles 51 and 52, the ferrite 53, and the polymer resin 54, thereby preventing a short-circuit between electrodes due to heat generation and improving the loss of the material due to high frequency, at the time of using the inductor.

Hereinafter, a method of manufacturing a multilayer inductor according to an embodiment of the present invention will be described.

First, the plurality of metal powder particles 51 and 52 having different sizes and the ferrite 53 are mixed in the polymer resin 54 to prepare a plurality of sheets, and a conductive circuit and a conductive via are formed on one surfaces of respective sheets.

The conductive circuit may be formed by thick film printing, coating, depositing, or sputtering conductive materials, onto the sheet, but is not limited thereto.

In addition, the conductive via may be provided by forming a through hole in respective sheets and filling the through hole with a conductive paste or the like, but is not limited thereto.

The portion of the inductor body 10 surrounding the conductive circuit and the conductive via may be filled with the polymer resin 54 mixed with the metal powder particles 51 and 52, and the ferrite 53.

Next, the plurality of sheets may be stacked to form the inductor body 10.

At this time, one ends of the conductive circuits formed on respective sheets may be connected to the conductive via formed in a vertically adjacent sheet to form the coil part 40 in which the plurality of conductive circuits are electrically connected to one another in a vertical direction.

Next, the plurality of sheets prepared by mixing the metal powder particles 51 and 52 and the ferrite 53 in the polymer resin 54 may be stacked to form the lower cover layer 12, and the inductor body 10 formed as described above may be stacked on the lower cover layer 12.

Next, the plurality of sheets prepared by mixing the metal powders 51 and 52 and the ferrite 53 in the polymer resin 54 may be stacked to form the upper cover layer 11, and the upper cover layer 11 may be stacked on an upper surface of the inductor body 10 stacked on the lower cover layer 12.

Meanwhile, the upper cover layer 11 and the lower cover layer 12 may be, respectively, formed by printing a paste formed of the material including the metal powder particles 51 and 52, the ferrite 53, and the polymer resin 54 on the upper surface and the lower surface of the inductor body 10 to have a predetermined thickness, instead of stacking the plurality of sheets.

Next, the inductor body 10 may be fired, and the pair of external electrodes 20 may be formed on both ends of the inductor body 10 so as to be electrically connected to both ends of the coil part 40 exposed through both ends of the fired inductor body 10.

The external electrodes 20 may be formed by submerging the inductor body 10 in the conductive paste, or by various methods such as printing, depositing, sputtering, or the like.

The conductive paste may be formed of a material including anyone of silver (Ag), copper (Cu), and a copper (Cu) alloy, but is not limited thereto.

In addition, a nickel (Ni) plating layer and a tin (Sn) plating layer may further be formed on the outer surfaces of the external electrodes 20, if needed.

Table 1 below shows characteristics of the inductor according to addition of ferrite.

TABLE 1

| | Classification | | | | | | |
|---|---|---|---|---|---|---|---|
| | Component (weight content ratio %) | | | | | | |
| | Metal 1 | Metal 2 | Metal 3 | Ferrite 1 | Ferrite 2 | | |
| | Particle Size (μm) | | | | | Characteristics | |
| | 20~25 | 28~33 | 4~5 | 1~3 | 0.5~1 | Ls (μm) | Q |
| Comparative | 70 | | 30 | | | 0.78 | 21.6 |
| Example 1 | | | | | | | |
| Comparative | | 70 | 30 | | | 0.83 | 21.9 |
| Example 2 | | | | | | | |
| Inventive | 70 | | 28 | 2 | | 0.82 | 22.6 |
| Example 1 | | | | | | | |
| Inventive | 70 | | 28 | | 2 | 0.83 | 22.4 |
| Example 2 | | | | | | | |
| Inventive | | 70 | 28 | 2 | | 0.89 | 22.5 |
| Example 3 | | | | | | | |
| Inventive | | 70 | 28 | | 2 | 0.90 | 21.9 |
| Example 4 | | | | | | | |

### <Characteristics of Inductor According to Addition of Ferrite>

Comparative Examples 1 and 2 represent the related art inductors without the addition of ferrite, while Inventive Examples 1 through 4 represent inductors manufactured by adding ferrite powder. The compositions and the particle sizes of the metal and the ferrite were varied to manufacture various inductors, and the characteristics thereof were then measured.

Here, Metal 1 was formed of 92 wt % of iron (Fe), 3.5 wt % of silicon (Si), and 4.5 wt % of chromium (Cr), and Metal 2 was formed of 99.5 wt % of iron (Fe) and 0.05 wt % of carbon (C). The composition of the ferrite was (NiCuZn)Fe₂O₄.

However, the present invention is not limited thereto, and the compositions and the contents of the metal 1 to 3, as well as the compositions and the contents of the ferrites 1 and 2 may be varied, if needed.

In addition, since the ferrite has an average particle size smaller than that of the smallest metal powder particle, the average particle size thereof was set to be 0.5 μm to 3 μm, smaller than the average particle size of Metal 3 having an average particle size of 4 μm to 5 μm.

It may be appreciated in referring to Table 1 above, that Ls and Q values in the case in which the inductor was manufactured by adding a small amount of ferrite, as described in Inventive Examples 1 through 4, were relatively excellent as compared with Comparative Examples 1 and 2 without the addition of the ferrite.

As set forth above, according to embodiments of the present invention, a multilayer inductor includes metal powder, ferrite, and polymer resin. By utilizing the advantages of metal, high current characteristics of a product can be improved, such as, preventing an inductance value from decreasing even at high current.

In addition, since the volume fraction of a magnetic component in an inductor body is increased due to the ferrite component included in the inductor body, the capacity of the inductor can be increased.

While the present invention has been shown and described in connection with the embodiments, it will be apparent to those skilled in the art that modifications and variations can be made without departing from the spirit and scope of the invention as defined by the appended claims.

What is claimed is:

1. A multilayer inductor comprising:
an inductor body formed of a material including metal powder particles, a ferrite, and a polymer resin;
a coil part having a conductive circuit and a conductive via formed in the inductor body; and
external electrodes formed on ends of the inductor body.

2. The multilayer inductor of claim 1, a portion of the inductor body surrounding the conductive circuit and the conductive via of the coil part is filled with the material including the metal powder particles, the ferrite, and the polymer resin.

3. The multilayer inductor of claim 1, further comprising:
an upper cover layer formed in an upper portion of the inductor body; and
a lower cover layer formed in a lower portion of the inductor body.

4. The multilayer inductor of claim 3, wherein the upper cover layer and the lower cover layer are formed of the material including the metal powder particles, the ferrite, and the polymer resin.

5. The multilayer inductor of claim 3, further comprising an insulating layer formed on outer surfaces of the inductor body, the upper cover layer and the lower cover layer.

6. The multilayer inductor of claim 1, wherein the metal powder particles have a particle size of 1 μm to 50 μm.

7. The multilayer inductor of claim 1, wherein the metal powder particles comprise a mixture of two or more metal powder particles having different particle sizes.

8. The multilayer inductor of claim 1, wherein the metal powder particles include one of iron-nickel (Fe—Ni) and iron-nickel-silicon (Fe—Ni—Si).

9. The multilayer inductor of claim 1, wherein the ferrite is a nickel-zinc-copper (Ni—Zn—Cu) ferrite.

10. The multilayer inductor of claim 1, wherein the polymer resin is a thermosetting resin including at least one of Novolac, Epoxy Resin, Phenoxy Type Epoxy Resin, BPA Type Epoxy Resin, BPF Type Epoxy Resin, Hydrogenated BPA Epoxy Resin, Dimer Acid Modified Epoxy Resin, Urethane Modified Epoxy Resin, Rubber Modified Epoxy Resin, and DCPD Type Epoxy Resin.

11. The multilayer inductor of claim 1, wherein the conductive circuit is formed of a material including at least one of silver (Ag), copper (Cu), and a copper alloy.

12. A method of manufacturing a multilayer inductor, the method comprising:
preparing a plurality of sheets having a conductive circuit and a conductive via formed thereon and therein and formed of a material including metal powder particles, a ferrite, and a polymer resin; and
forming an inductor body by stacking the plurality of sheets while allowing one end of the conductive circuit formed on each sheet to contact the conductive via formed in an adjacent sheet to thereby form a coil part.

13. The method of claim 12, wherein, in the preparing of the plurality of sheets, a portion of the inductor body surrounding the conductive circuit and the conductive via is formed of the material including the metal powder particles, the ferrite, and the polymer resin.

14. The method of claim 12, further comprising, after the forming of the inductor body:
forming a lower cover layer in a lower portion of the inductor body, the lower cover layer being formed of the material including the metal powder particles, the ferrite, and the polymer resin; and
forming an upper cover layer in an upper portion of the inductor body, the upper cover layer being formed of the material including the metal powder particles, the ferrite, and the polymer resin.

15. The method of claim 14, wherein the upper cover layer and the lower cover layer are formed by stacking a plurality of cover sheets, the cover sheets being formed of a mixture of the metal powder particles and the ferrite in the polymer resin.

16. The method of claim 14, wherein the upper cover layer and the lower cover layer are formed by printing a paste on an upper surface and a lower surface of the inductor body, respectively, the paste being formed of the material including the metal powder particles, the ferrite, and the polymer resin.

17. The method of claim 12, further comprising, after the forming of the inductor body, forming external electrodes on ends of the inductor body.
